(19) United States
(12) Patent Application Publication
(10) Pub. No.: US 2008/0004990 A1
(43) Pub. Date: Jan. 3, 2008

(54) VIRTUAL SPOT MARKET FOR ADVERTISEMENTS

(75) Inventors: Gary W. Flake, Bellevue, WA (US); Alexander G. Gounares, Kirkland, WA (US); William H. Gates, Medina, WA (US); Kenneth A. Moss, Mercer Island, WA (US); Susan T. Dumais, Kirkland, WA (US); Ramez Naam, Seattle, WA (US); Eric J. Horvitz, Kirkland, WA (US); Joshua T. Goodman, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/427,312

(22) Filed: Jun. 28, 2006

(51) Int. Cl. G06Q 30/00

(52) U.S. Cl. 705/27

(57) ABSTRACT

Architecture that facilitates online advertising taking on characteristics of a commodities market approach to purchasing advertising space, options for ad space and a futures market for online ad space. Available advertising space is identified and aggregated, and subsets of the aggregated ad space are offered for purchase using a commodities market-based approach. The architecture facilitates revenue-sharing paradigms, coupon delivery, targeted advertising, point-of-sale transactions, inventory control, just-in-time delivery of ads, content and product/services, value-based advertising models, etc. The architecture comprises an aggregation component that aggregates advertisement space information associated with online advertisements, and a transaction component that facilitates transacting subsets of the aggregated advertisement space information to bidders as a function of supply and demand. The aggregation component receives information about online advertising space that is now available, that will become available in the future, and that is predicted by prediction analysis to become available in the future. Advertisements and/or ad space can be specified based on dynamic sensing of contextual cues.

### CROSS REFERENCE TO RELATED APPLICATIONS

This application is related to co-pending U.S. patent application Ser. No. ______ (Atty. Dkt. No. MSFTP1422US) entitled “AUCTIONING FOR VIDEO AND AUDIO ADVERTISING” (Flake et al.) filed of even date, the entirety of which is incorporated herein by reference.

### BACKGROUND

The Internet provides unprecedented access to an ever-increasing number of potential online customers ranging from businesses to individuals. Money expended for online advertising in the United States alone, is in the billions of dollars per year, and continues to increase with no end in sight. Accordingly, businesses recognize the value in online advertising and continue to seek better ways to reach these potential customers with information about their products and services.

Application of conventional business marketing and advertising contracting techniques to online advertising is not as efficient and effective as it could be. For example, traditional advertising techniques involve purchasing rights to present an advertisement (or “ad”) in pre-designated time slots over mainstream media channels to reach a wide audience of viewers (for television) and listeners (for radio). These rights can be contracted on a “first come-first served” basis. The corporation hires an advertising agency to develop advertisements around certain products or services that the company wishes to market. Due to costs associated with such advertising techniques, typically only large corporations with substantial monetary resources are able to afford advertising at such level. In less costly scenarios, companies pay for advertisements to be posted along heavily traveled areas, whether vehicular traffic or foot traffic, as principal means for reaching viewers with the hope that he or she will see the advertisement and make a purchase.

The Internet, however, and its myriad of websites and millions of users present a whole different challenge to contracting and presenting advertisements. A company contacts the website owner and procures ad space on one or more web pages hosted at that site. However, contracting to present advertising on multiple websites can be a daunting task, as is typically the case under current mechanisms.

Ads can be presented on web pages in different forms and types of multimedia content where the size of the web page real estate can be a cost factor, as well as the position of the ad on the web page. In that online user activities and access information can now be tracked in the form of cookies, for example, thereby providing information about the buying habits, goals, intentions, and needs large numbers of users, it then becomes possible to target groups of users, for example, based on this information alone. Accordingly, the quality and value received from online advertising can translate into potentially huge returns to the advertising dollars of businesses.

However, conventional online advertising mechanisms lack the capability of dealing with the large numbers of advertising portals (e.g., websites, user devices, . . . ) forcing businesses to continue to search for new and more effective mechanisms for obtaining return on advertising dollars.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The invention contemplates online advertising taking on characteristics of commodities, and an eventual commodities market approach to purchasing advertising (or “ad”) space, options for ad space, and even a futures market for online ad space. Available advertising space is identified and aggregated (using a variety of metrics), and subsets of the aggregated ad space are offered for purchase using a commodities market-based approach. Through such approach, convergence toward an efficient online ad market is achieved. The cost and availability for ad space can be a direct function of supply and demand, as well as expected supply and demand.

The architecture can also facilitate various revenue-sharing paradigms, coupon delivery, targeted advertising, point-of-sale transactions, inventory control, just-in-time delivery of ads, content and product/services, and value-based advertising models, for example.

In accordance with the invention, corporations no longer need to negotiate with individual websites for ad space, but can purchase bulk ad space within this novel commodities-based ad market. For example, a company can purchase 100,000 options for Class A travel ads (e.g., ads located on top ten travel websites with prime display space positioning and temporal space).

Accordingly, the invention disclosed and claimed herein, in one aspect thereof, comprises a computer-implemented system that facilitates sale of online advertising space. The system includes an aggregation component that aggregates advertisement space information associated with online advertisements, and a transaction component that facilitates transacting subsets of the aggregated advertisement space information to bidders as a function of supply and demand. The aggregation component receives information about online advertising space that is now available, that will become available in the future, and/or that is predicted by prediction analysis to become available in the future. The subsets of the aggregated advertisement space information can be valuated based on supply and demand. Additionally, the transaction component facilitates a purchase of options and futures to buy online advertising space.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system that facilitates the sale of online advertising space in accordance with an innovative aspect.

FIG. 2 illustrates a methodology of transacting online advertising space in accordance with the subject innovation.

FIG. 3 illustrates a detailed block diagram of an alternative system that facilitates transacting online advertising space in accordance with another aspect.

FIG. 4 illustrates a methodology of processing received ad space information into categories or classes in accordance with another aspect of the innovation.

FIG. 5 illustrates a methodology of processing received advertisement space information in accordance with an innovative aspect.

FIG. 6 illustrates an alternative implementation of a system that facilitates the processing of online advertising space and related aspects.

FIG. 7 illustrates a methodology of processing sale of ad space based on characteristics (e.g., coupons) associated therewith.

FIG. 8 illustrates a flow diagram of a methodology of transacting ad space for informational purposes according to an aspect.

FIG. 9 illustrates a flow diagram of a methodology of processing ad space information based on availability.

FIG. 10 illustrates a flow diagram of a methodology of transacting advertising according to an auction format.

FIG. 11 illustrates a flow diagram of a methodology of developing profiles and/or models for system processes.

FIG. 12 illustrates a block diagram of a computer operable to execute the disclosed advertising space transaction architecture.

FIG. 13 illustrates a schematic block diagram of an exemplary computing environment.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The invention comprises online advertising taking on characteristics of commodities, and an eventual commodities market approach to purchasing advertising (or “ad”) space, options for ad space, and even a futures market for online ad space. Available advertising space is identified and aggregated (using a variety of metrics), and subsets of the aggregated ad space are offered for purchase using a commodities market-based approach. Through such approach, convergence toward an efficient online ad market is achieved. The cost and availability for ad space can be a direct function of supply and demand, as well as expected supply and demand.

Corporations no longer need to negotiate with individual websites for ad space, but can purchase bulk ad space within this novel commodities-based ad market. For example, a company can purchase 100,000 options for Class A travel ads (e.g., ads located on top ten travel websites with prime display space positioning and temporal space). Additionally, the architecture facilitates various revenue-sharing paradigms, coupon delivery, targeted advertising, point-of-sale transactions, inventory control, just-in-time delivery of ads, content and product/services, value-based advertising models, and so on.

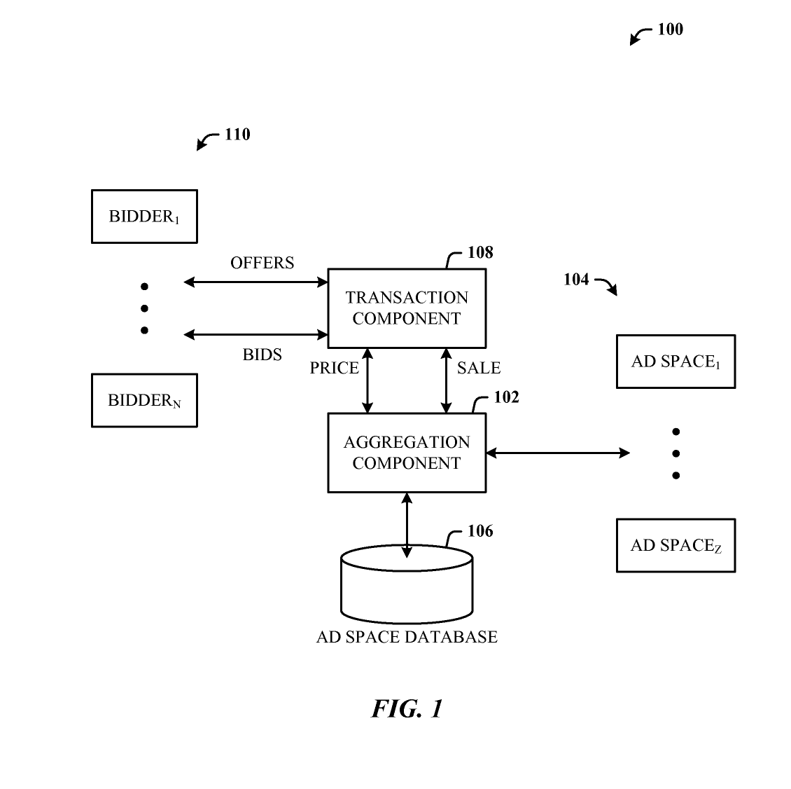

Referring initially to the drawings, FIG. 1 illustrates a computer-implemented system 100 that facilitates sale of online advertising space. The system 100 includes an aggregation component 102 that receives and aggregates advertisement space information related to ad space 104 (denoted AD SPACE₁, . . . , AD SPACE_{Z}, where Z is an integer) associated with online advertisements from multiple sources (e.g., websites) that post or present such advertising information. An ad space database 106 associated with the aggregation component 102 serves to store the ad space information and other related data, and to provide access to the ad space information and related data for analysis and processing.

A transaction component 108 interfaces to the aggregation component 102 to facilitate transacting subsets of the advertisement space 104 (that has been aggregated) to bidders 110 (denoted BIDDER₁, . . . BIDDER_{N}, where N is an integer) as a function of supply and demand. The transaction can include offer and acceptance of bids placed on ad space by the bidders 110. The data communications between the aggregation component 102 and the transaction component 108 can include at least price and sale information.

The aggregation component 102 receives the ad space information about online advertising space 104 that is now available, that will become available in the future, and that is predicted by prediction analysis to become available in the future. The subsets of the advertisement space information that is aggregated can be valuated based on supply and demand, for example. Additionally, the transaction component 108 facilitates a purchase of options to buy online advertising space.

The aggregation component 102 can furthered be designed and configured to provide data analysis in the form of clustering ad space information based on related information. For example, ad space suitable for accommodating audio content, as statistically computed, can be clustered for sale. In another example, ad space that tends to generate lower revenues can be clustered for sale in blocks of lower priced ad space. In yet another example, the system 100 can package ad space according to clusters of varying characteristics such as packing ad space that tends to return higher revenues with ad space that tends to generate mediocre or lower revenue. This can be accomplished, in one example, via a classifier, as described in greater detailed infra.

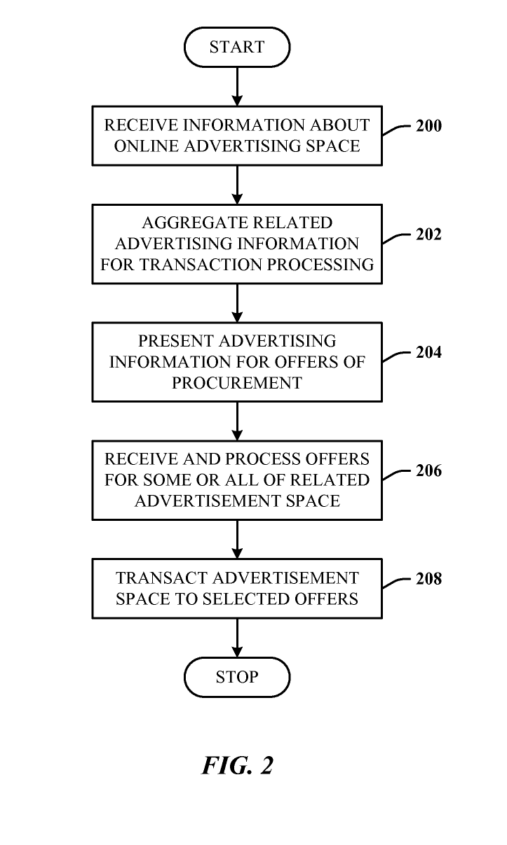

FIG. 2 illustrates a methodology of transacting online advertising space in accordance with the subject innovation. While, for purposes of simplicity of explanation, the one or more methodologies shown herein, for example, in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, information is received about online advertising space. The information can be pushed to the aggregation component from remote systems on regular basis. For example, once a week, this ad space information can be communicated to the aggregation component. In an alternative implementation, the ad space information is pushed to the aggregation component asynchronously, that is, anytime it becomes available, will become available, and/or is predicted to come available in the future. In yet another implementation, operating separately or in combination with the aforementioned processes, the aggregation component pulls the ad space information from predetermined (or subscribing) sites or sources, on a regular basis, for example.

At 202, the aggregation component collects the ad space information for transaction processing. Aggregation can be as simple as merely listing the information as it is received or as complex as grouping or clustering the information based on information properties (e.g., ad file size, resolution required, ad real estate dimensions, availability, . . . ), types (e.g., audio versus video), categories (e.g., automobile advertising versus travel advertising, as well as other data related to the ad space (e.g., duration of presentation, rotation, time to be presented, time to be terminated, . . . ), ad source (e.g., vendor supplying the ad space, vendor suggested price for the ad space, vendor network address, . . . ), and ad destination (e.g., site that hosts the ad space, destination network address, . . . ).

The invention also covers the specification of advertisements and/or ad space based on the status of contextual cues that can be sensed in a dynamic manner. For example, advertisements can be sold and priced based on the location of people, such as for drivers or passengers in automobiles at particular locations (e.g., particular stretches of road) as revealed by GPS-centric location sensing. Other attributes can be considered. For example, advertising commodities can be based on a specification of the velocity of drivers, specific routes being traversed based on requests for directions, the time of day, and even the current congestion on the route or routes proximal to the current route of drivers. For example, spot markets for advertisements might specify the pushing of a particular number of impressions to cars likely stuck in traffic at particular locations during particular hours.

Purchase of such context-dependent advertisement commodities can be made in advance based on these attributes. However, the methods also support real-time sales of advertisements with commitments to push impressions based on the purchase of the advertising commodities. Such advertising sales can include real-time auctions with deadlines at different times of day, for example, auctions occurring every 15 minutes on weekdays at rush hour, whereby the auctions are focused on optimizing advertisement revenue at each deadline.

At 204, once the ad space information is aggregated, it can be organized and presented for pricing (e.g., initial pricing) and offers made for purchase. The offers can be determined based on supply and demand, that is, the prevailing market prices. This can be determined by an auction format where the highest bid wins the ad space. Moreover, this can be for a single ad space, for multiple ad spaces, and/or for block or groups of ad space, for example. At 206, offers are received and processed for some or all related ad space. At 208, once the offers are accepted, the transaction is complete. In another implementation, the offer can be withdrawn after the bid has been received and the bid process has closed.

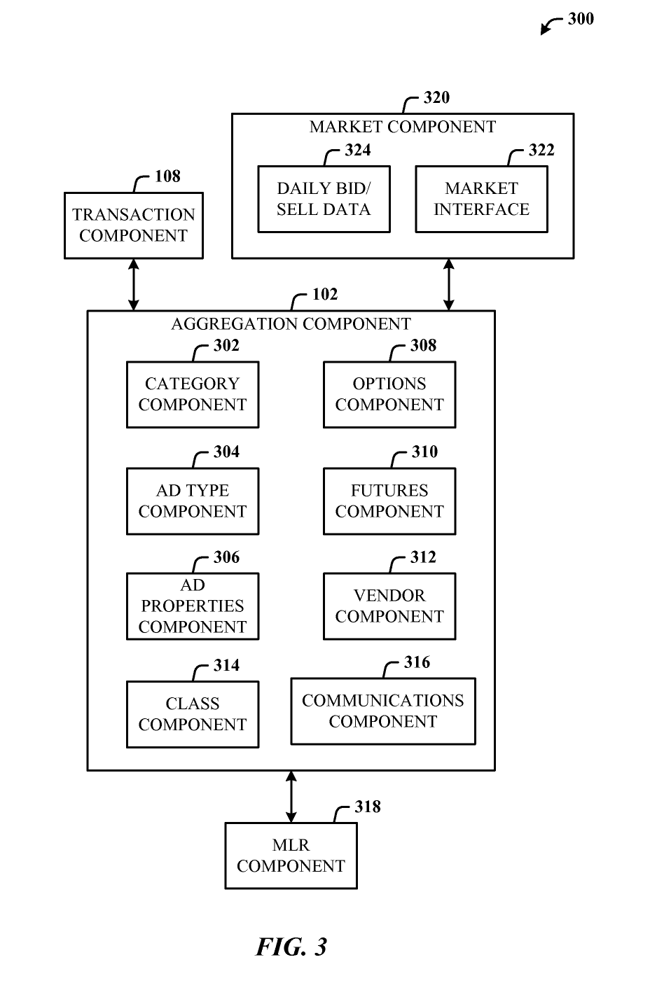

Referring now to FIG. 3, there is illustrated a detailed block diagram of an alternative system 300 that facilitates the transacting of online advertising space in accordance with another aspect. The system 300 includes the aggregation component 102 and the transaction component 108 of FIG. 1. Additionally, the aggregation component 102 can include other components that facilitate aggregation, such as, for example, a category component 302 is provided that categorizes the incoming ad space information. The categories can include groupings or collections related to automobiles, travel, clothes, movies, and news channels, to name just a few categories.

An ad type component 304 includes information related to the format of the advertising data. For example, the advertising can be in the format of a video file, audio file, text file, image file, hyperlinked text, hyperlinked images, animated content file, and so on.

The aggregation component 102 can further include an ad properties component 306 that stores ad information related to page real estate parameters. For example, the ad properties information can include file size, playing time (e.g., for a video or audio file), dimensions of the ad space on the page or document, position of the ad in the page or document (e.g., at center, toward the center, near corners, in scrolling sub-windows, . . . ), a combination of ad types utilized in the same ad space (e.g., animated text with one or more images, audio with a video presentation, . . . ), rotation parameters associated with rotating multiple ads through the same page space (e.g., how often to rotate between multiple ads), temporal information related to the duration that the ad will be presented (e.g., one week, one month, . . . ), such contextual cues as, for example, displaying advertisements only when users stop walking, driving (e.g., stop their car for at least some specified period of time), or talking, and so on.

An options component 308 facilitates the presentation and processing of options to purchase ad space. Options are contracts that give the owner the right to buy or sell the stock at a specific price by a specific date. For example, as indicated supra, a company (or other bidder entity) can place an order for and complete the purchase of options for ad space (e.g., ads located on top ten travel websites, and with prime display space positioning such as at typical eye level across the center and near the top of the page or document). These options can include ad space that will become available in the near future due to, for example, existing ads in available ad space aging out according to contract terms.

The aggregation component 102 can also employ a futures component 310 that receives and stores bids related to futures speculation on ad space. A futures contract is a type of derivative instrument, or financial contract, in which two parties agree to transact a set of financial instruments or physical commodities for future delivery at a particular price. In the context of advertising space, an entity buying a futures contract is basically agreeing to buy ad space for a set price that a seller has not yet produced. Accordingly, buyers and sellers in the futures market for ad space primarily enter into futures contracts to hedge risk or speculate rather than to exchange physical goods (a primary activity of the cash or spot market). Thus, futures contracts can be used as financial instruments for speculators, as well as by producers and consumers.

A vendor component 312 stores and facilitates the processing of vendor information received and related to entities that are bidding as well as selling ad space. A class component 314 facilitates processing the ad space information in classes (e.g., Class A, Class B, . . . ) according to value and features. For example, Class A ad space can be associated with ad space located on the top five corporate websites and having prime display space positioning.

In another implementation, class ad space may have restrictions related to minimum number of ad spaces that should be purchased (e.g., no less than 2,500) and based on an specific type of entity (e.g., institution versus individual vendor) that can purchase the ad space, while Class C ad space can be purchased with no minimum quantity and with no restrictions on who can make the purchase (e.g., institution and individual purchasers).

A communications component 316 facilitates transmitting offers to sell ad space to vendors and receiving offers to buy the ad space from the vendors. As indicated herein, the transaction information can be also pushed from the communications component 316 to existing subscribers and/or to prospective subscribers.

The system 300 can also employ a machine learning and reasoning (MLR) component 318 which facilitates automating one or more features in accordance with the subject innovation. The subject invention (e.g., in connection with predicting) can employ various MLR-based schemes for carrying out various aspects thereof. For example, a process for determining when to lock in market pricing for ad space can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or other statistical analysis (e.g., one factoring into the analysis utilities and costs to maximize the expected value to one or more people) to prognose or infer an action that a user desires to be automatically performed.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of ranking or priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions according to predetermined criteria.

In one example, based on historical information of bids, offers, sales and buys, and even market dynamics, the MLR component 318 can learn and reason when to prompt an entity for bids on ad space. Moreover, the MLR component 318 can reason based on rising or falling market information as received from major stock market exchange systems such as the New York Stock Exchange®, NASDAQ®, and the like, that it will be beneficial to lock in transactions (or contracts) now, rather than later. This information can be conveyed to a vendor or purchaser, for example, as a service for subscribing to the virtual ad market architecture of the subject invention.

In support of interfacing to the major financial entities mentioned above, the system 300 can further include a market component 320 that can interface to at least the network-based market entities mentioned above to exchange market information via a market interface component 322. For example, daily offer and bid data 324 can be processed for transactions via the transaction component 108.

It is to be understood that any or all of the components (302, 304, 306, 308, 310, 312, 314, and 316) can be employed separately from the aggregation component 102. Additionally, the MLR component 318 can be included as part of the aggregation component 102. Still further, the components (302, 304, 306, 308, 310, 312, 314, and 316) can be combined in any manner deemed suitable for providing the functions described herein.

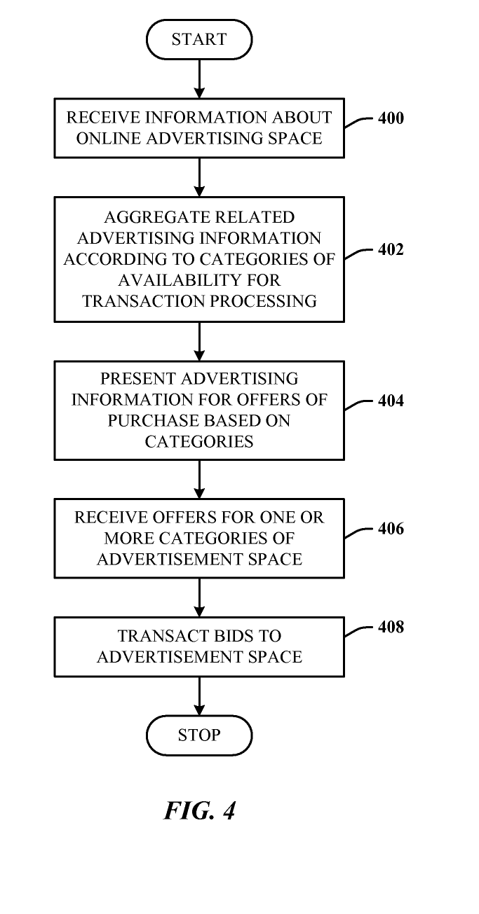

FIG. 4 illustrates a methodology of processing received ad space information into categories or classes in accordance with another aspect of the innovation. At 400, information is received about online advertising space. At 402, related advertising space can be grouped according to categories of ad space information for transaction processing. At 404, the advertising information is presented or made available for offers of purchase based on the categories. This can be accomplished by e-mailing the ad information to selected subscribers, for example, posting this information on a secure website whereby only authorized entities can interact with the offer, or making a general public offering on an open web page. At 406, the system receives offers for one or more categories of ad space. At 408, the offers (or bids) received are transacted. The transaction process can include rejecting the offer, accepting the offer with restrictions or limitations (e.g., a partial purchase of the whole amount), and accepting the offer with no restrictions or limitations, for example. These are examples of only a few implementations whereby an offer can be processed, and thus, should not be construed as limiting in any way.

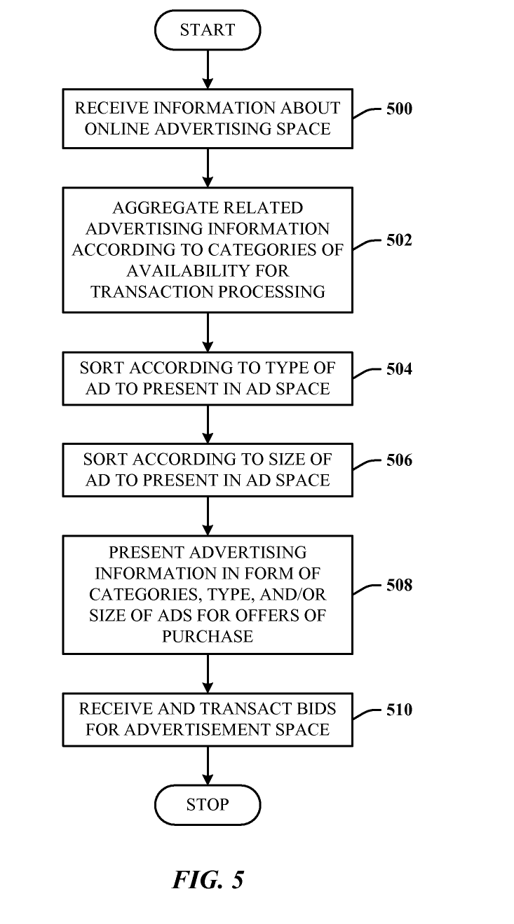

FIG. 5 illustrates a methodology of processing received advertisement space information in accordance with an innovative aspect. At 500, information about online advertising space is received for aggregation processing. At 502, the ad space information is aggregated according to categories of availability, and in preparation for transaction processing. At 504, the ad space information is sorted according to the type of ads (e.g., text, image, video, and combinations thereof) to be presented in the ad space. At 506, the ad space information can also be sorted according to size, dimensions, and area. At 508, the ad space information is then placed out for bid according to any of the above information (e.g., type, properties, . . . ). At 510, bids are received from one or more potential purchasers, and processed to transact (e.g., for a contract) the ad space.

The novel architecture also facilitates various revenue-sharing paradigms, coupon delivery, targeted advertising, point-of-sale transactions, inventory control, just-in-time delivery of ads, content and product/services, value-based advertising models, and so on.

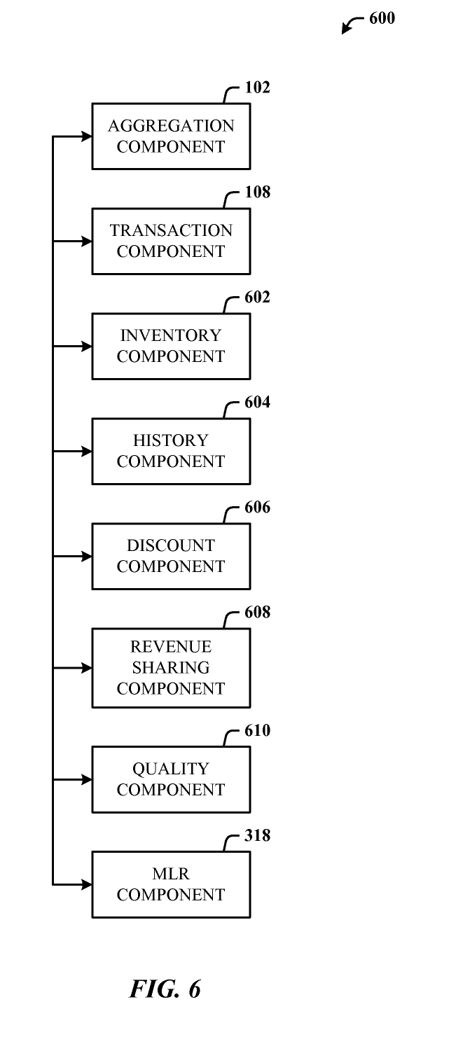

FIG. 6 illustrates an alternative implementation of a system 600 that facilitates the processing of online advertising space and related aspects. The system 600 can include the aggregation component 102, transaction component 108, and MLR component 318, aspects of which have been described hereinabove.

Additionally, the system 600 can include an inventory component 602 that tracks the inventory of ad space information associated with web page ad space currently available for bid, and which is being received for aggregation by the aggregation component 102. Working in combination with a history component 604, trend information related to market swings in what vendors are seeking for ad space and/or placing for sale can be generated and analyzed. For example, market swings in supply and demand for web page ad space can be affected by local, regional, national, and even international events. Supply and demand can also be based on seasonal information, geographic information, and demographic information, as well. Accordingly, such information can be considered when pricing blocks of ad space for “national” or large corporation web pages versus ad space transacted for more localized (or geographically focused) advertising.

The inventory component 602 also facilitates basing ad space value (and pricing) on available inventory of ad space (an inventory-centric approach). Thus, supply and demand is not based on the overall market per se, but on inventory for that particular system. It is to be appreciated that ad space can be grouped based on intended use, and which uses can be relegated to inventory and processing by separate systems. For example, all medical ad space transactions can be inventoried and routed to a first system, while all automotive ad space transactions are inventoried and routed to a second system.

The history component 604 facilitates storing and processing data related to past events and processes. Historical data can be utilized to develop models and/or profiles on usage related to many aspects of the subject architecture. For example, vendor (or bidder) profiles can be developed and stored for entities subscribing to the subject architecture. The MLR component 318 can be used to update profiles as needed. Models can be developed and continually evolved as processes change over time. For example, models related to the ad space content can be generated, as well as models for trends in access to specific web pages and/or websites. The amount and quality of information received and available for analysis and processing has great value in determining purchasing habits of users and businesses, and demographical information obtained, for example, any or all of which can be a factor in the pricing and sale of the ad space.

Profiles can also be generated as to how users interact with the ad space as a means of determining its values in future transactions. Moreover, how users transact purchases with personal account information (e.g., credit card, bank accounts, . . . ) can be monitored and utilized. The profile information can be further employed as a means for personalizing ad content, and perhaps even personalizing the way the ad is presented. For example, given a user name, the ad can be presented as addressed specifically to that user. Accordingly, if a block of 1,000 ad space locations includes such an option or capability, this can add to the value of the ad space for bidding purposes. In another example, if it is determined that a use tends to react more favorably to ad content presented in a certain location on the web page, this can be personalized in the profile information such that ad space for that person can be priced more. Again, this overall personalization capability can add value to the ad space for block sale purposes.

The system 600 can also include a discount (e.g., coupons, rewards, . . . component 606 that processes reduced rates in terms of issuing coupons and processing rebates, for example, that serve as enticements to purchasing blocks of ad space, as well as for discounts for products and/or services associated with the block of ad space. For example, a bidding vendor may initially choose a block of 5,000 web locations for ad space, but be enticed to reconsider a block of 7,000 locations where a reduced price is offered. The term “locations” can be defined to include one individual web page as a location, as well as a single website (that hosts many different web pages) as a location. Accordingly, the purchase of 7,000 ad space locations can include multiple web pages from different sites, as well as multiple different websites each having a single web page or many web pages. Thus, blocks of ad space can be offered for sale based only website locations, web pages, or a combination of both web pages and websites.

The system 600 can also include a revenue-sharing component 608 that facilitates sharing returns on purchased ad space. For example, prime ad space on websites that routinely experience millions of hits per day can be sold in blocks that also require a percentage share of the computed return in revenue associated with the ad and locations. Conventional marketing techniques can be employed to determine if the ads presented in the ad space had a positive impact on sale of the products and/or services.

Although the description has focused primarily on advertising, the “ad space” can be bought and sold based not only for advertising purposes, but also for purely informational purposes. This can be beneficial to governmental entities (or agencies) that want to get information to citizens, for example. In one application, medical information can be broadcast to users who access a web page or website simply to provide information related to new medical processes, medicines, alerts, and so on. Accordingly, a quality component 610 can be employed assess the value of ad space based on the quality of the information to be presented therein.

The quality component 610 can also serve to monitor and filter content quality related to spam. In other words, many online merchants (e.g., computer sales) are so automated that the sale of a miss-priced product can go un-noticed, if alerts are not installed to catch such problems. Similarly, it is appreciated that the subject architecture can be so automated that large blocks of ad space can be sold and content inserted thereinto for presentation so quickly that certain controls should be implemented to prevent unacceptable content from being presented on such a large scale. This can be controlled by the quality component 610, or facilitated by the quality component 610 in combination with other systems to ensure that only the desired content is allowed to be presented.

One way of providing a means to monitor user and/or vendor feedback is to allow an option to opt-in or opt-out receipt of the ads. The fact that users may opt to receive the advertisement can be inferred to provide additional value to the ad space itself, to the ad content, and/or means of presentation, any or all of which can be employed to impact the value of that ad space.

The MLR component 318 functions as before by learning and reasoning about other functions occurring in the system 600 so as to facilitate automation and/or updating of system processes. For example, the MLR component 318 can learn and reason about trends in ad space availability based on inventory as managed by the inventory component 602 and historical information processed in the history component 604. Moreover, the MLR component 318 can reason about aggregation processes such that based on historical information, aggregation can be changed to group ad space differently than has been done in the past to achieve a greater return for investors. These are only but a few of the many aspects that can be learned and reasoned when using the MLR component 318, and should not be construed as limiting in any way.

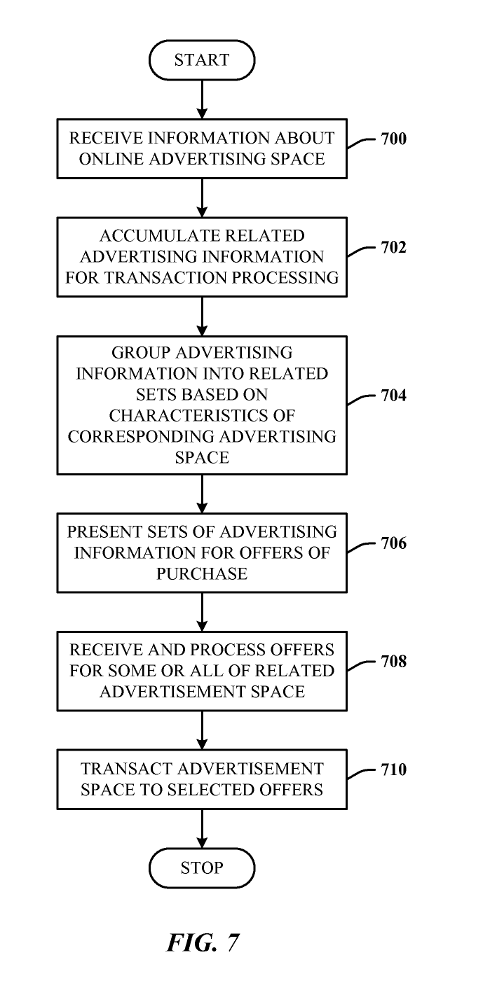

Referring now to FIG. 7, there is illustrated a methodology of processing sale of ad space based on characteristics (e.g., coupons) associated therewith. At 700, information is received about online ad space. At 702, the ad space information is accumulated in preparation for at least transaction processing. At 704, the ad space information is grouped into related sets based on characteristics of corresponding ad space. At 706, the sets are presented for offers of purchase. At 708, the offers are received and processed for some or all of the related sets of ad space. At 710, the offers are transacted, which can include rejecting the offers, accepting the offers, and also bartering through counteroffers, and the like. This can also include auctioning the ad space using online auctioning methodologies.

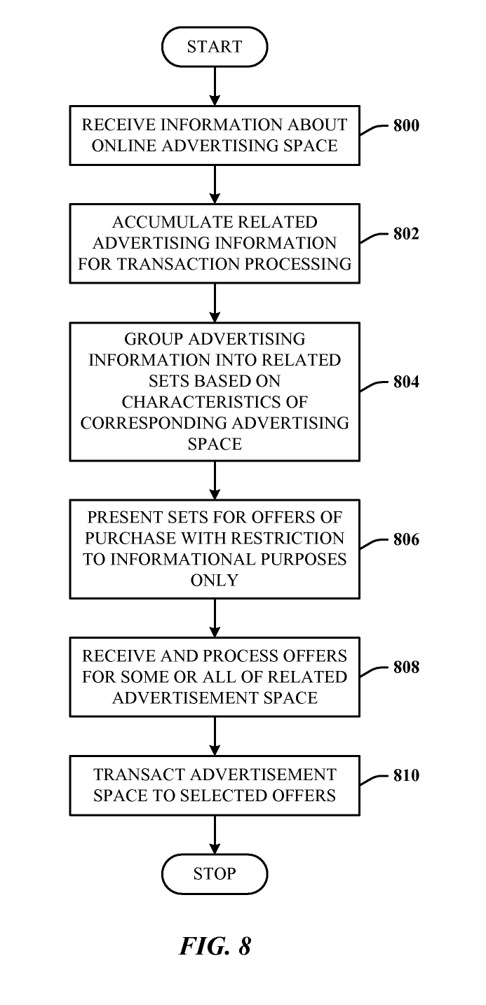

FIG. 8 illustrates a flow diagram of a methodology of transacting ad space for informational purposes according to an aspect. At 800, ad space information is received about online ad space. At 802, the ad space information is accumulated in preparation for at least transaction processing. At 804, the ad space information can be grouped into related sets based on characteristics of the corresponding ad space, such as size, dimensions, and content which can be employed, although this is not a requirement. At 806, the sets are presented for bids, and restricted to informational purposes only. As indicated supra, such offers can be presented to bidders who typically deal with informational presentations, such as governmental entities, and health and public safety entities. At 808, the offers are received and processed for some or all of the related sets of ad space. At 810, the offers are transacted, which can include rejecting the offers, accepting the offers, and also bartering through counteroffers, and the like. As before, this can also include auctioning the ad space using online auctioning methodologies.

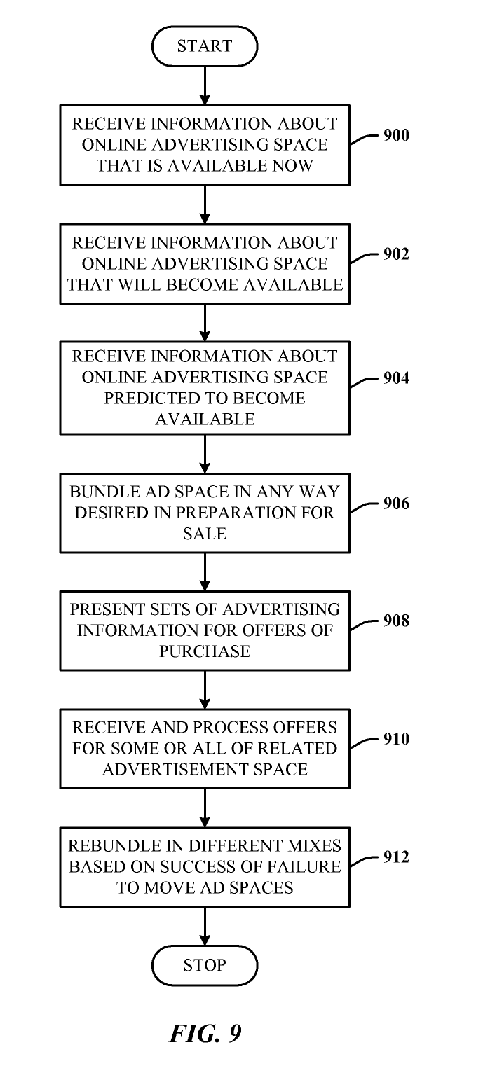

FIG. 9 illustrates a flow diagram of a methodology of processing ad space information based on availability. At 900, the aggregation component receives ad space information based on ad space that is now available. This can be determined by monitoring existing contracts for space that are known and that have expired, and/or simply by the fact that this information has been retrieved from subscribing websites. At 902, the aggregation component receives ad space information based on ad space that will be coming available. Again, this can be determined by monitoring existing contracts from existing subscribers and/or obtaining information from external sources.

At 904, the aggregation component receives ad space information based on ad space that is predicted to come available. This can be determined by monitoring trend information which interpolated indicates that certain ad space may become available for any number of reasons. For example, it is within contemplation of the subject invention that ad space can be sold with conditions that allow the space to be returned for immediate sale to subsequent bidders based on performance of the ad space and associated content. Thus, if the ad space is deemed to be “under performing” in terms of click activity and/or computed revenue due to predetermined criteria agreed upon between the web location and the vendor, and based on “hits” as logged by the system, it can be predicted that eventually, the ad space may become available within a certain time.

At 906, the ad space can be bundled or packaged in many different ways for suited purposes. For example, “under-performing” ad space can be bundled with performing ad space. Various metrics can be employed to assign values or some measure of value and/or quality to ad space, web locations (e.g., pages, sites, . . . ) in order to provide some valuation that bidders can utilize in terms of bidding on ad space, whether existing ad space, soon-to-be-available ad space, and predicted-to-be-available ad space.

At 908, sets of ad space are presented for bid and/or purchase. At 910, offers are received and processed for some or all related ad space. At 912, based on the success or failure so sell the sets of bundled ad space, or to receive acceptable bids, the sets can be reconfigured or rebundled into new and what would be considered to be more attractive mixes. This capability further supports the concept of options and futures with respect to advertising space in accordance with the disclosed architecture. In other words, bundling of the ad space information in novel ways can make the ad space more valuable, and hence, more attractive to investors and vendors alike.

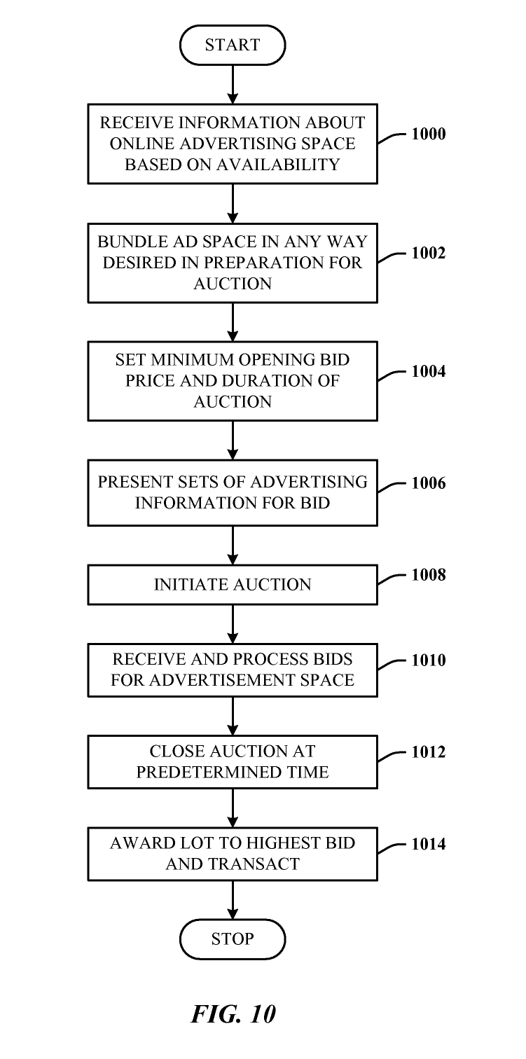

FIG. 10 illustrates a flow diagram of a methodology of transacting advertising according to an auction format. At 1000, ad space information is received based on availability. As indicated supra, this can be for ad space that is now available, soon-to-be-available, and/or predicted-to-be-available. At 1002, the ad space is bundled in any way desired in preparation of for auction. At 1004, the minimum opening bid and duration of the auction are set. At 1006, the bundled set or sets of ad space are presented for inspection before the auction begins. At 1008, the auction is initiated. At 1010, bids are received, processed, and presented for other bidders to see. At 1012, the auction is closed. At 1014, the highest bid is awarded the “lot” or bundle of ad space, and transacted for purchase.

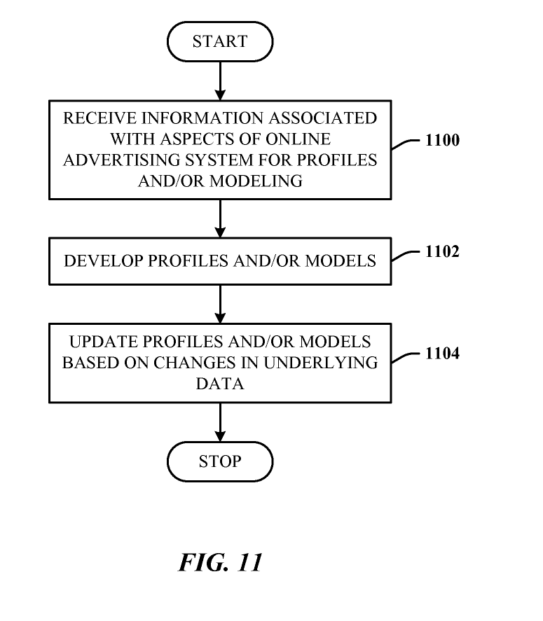

FIG. 11 illustrates a flow diagram of a methodology of developing profiles and/or models for system processes. At 1100, data associated with aspects of the online advertising architecture is received. This can include subscriber profile information obtained during an initial subscription process, as well as other subscriber information developed from subscriber interaction during the bidding and transaction processes, for example. With respect to modeling, this can also include receiving and processing information related to various categories of ad space, ad types, ad properties, ad classes, historical information, inventory levels, quality information, revenue-sharing data, options, futures, and any other data made available by the innovative architecture.

At 1102, profiles and/or models are developed and stored. Profiles can be developed for a number of different entities, including, but not limited to, user profiles, system profiles, website profiles, and so on. Similarly, models can be developed, trained, and employed based on historical data, for example, as well as other information described above. Areas where modeling can be beneficial include inventory analysis, and valuations of ad space based on web locations (e.g., web pages and websites), for example.

At 1104, profiles and/or models can be updated based on changes in underlying data. For example, this can include market swings that affect valuations of ad space.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

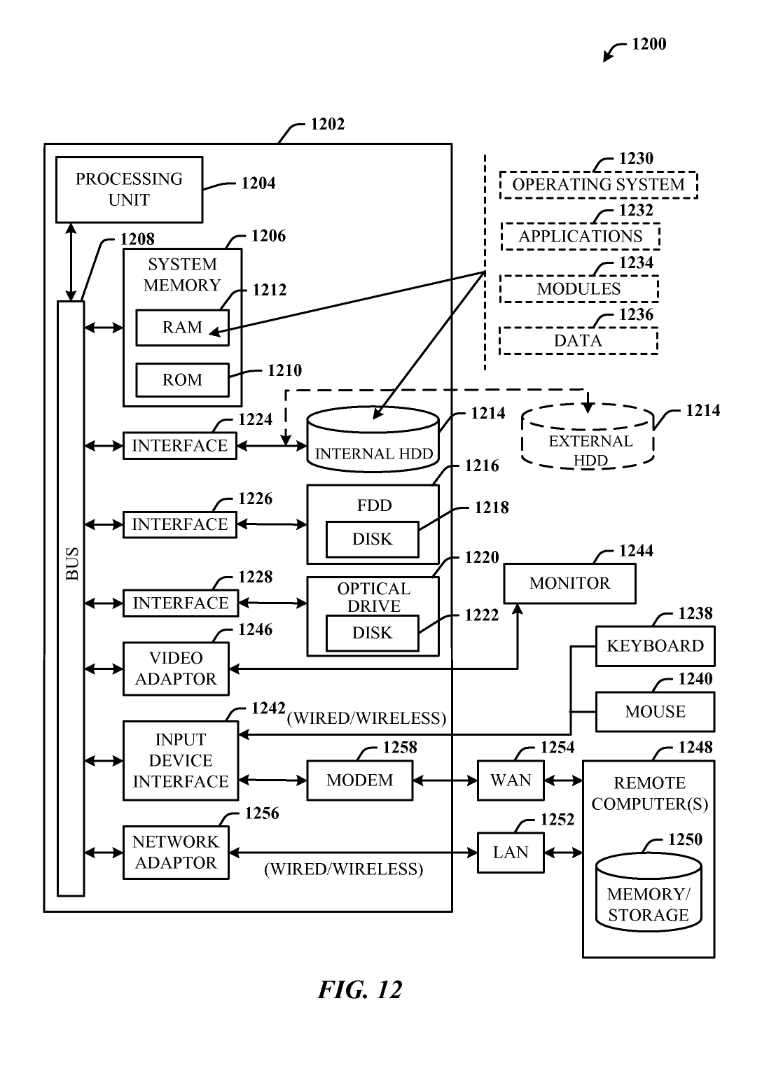

Referring now to FIG. 12, there is illustrated a block diagram of a computer operable to execute the disclosed advertising space transaction architecture. In order to provide additional context for various aspects thereof, FIG. 12 and the following discussion are intended to provide a brief, general description of a suitable computing environment 1200 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 12, the exemplary environment 1200 for implementing various aspects includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is to be appreciated that the innovation can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adaptor 1256 may facilitate wired or wireless communication to the LAN 1252, which may also include a wireless access point disposed thereon for communicating with the wireless adaptor 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+Mbps in the 2.4 GHz band. Products can contain more than one band (e.g., dual band), so the networks can provide real-world performance similar to the basic 10BaseT wired Ethernet networks used in many offices.

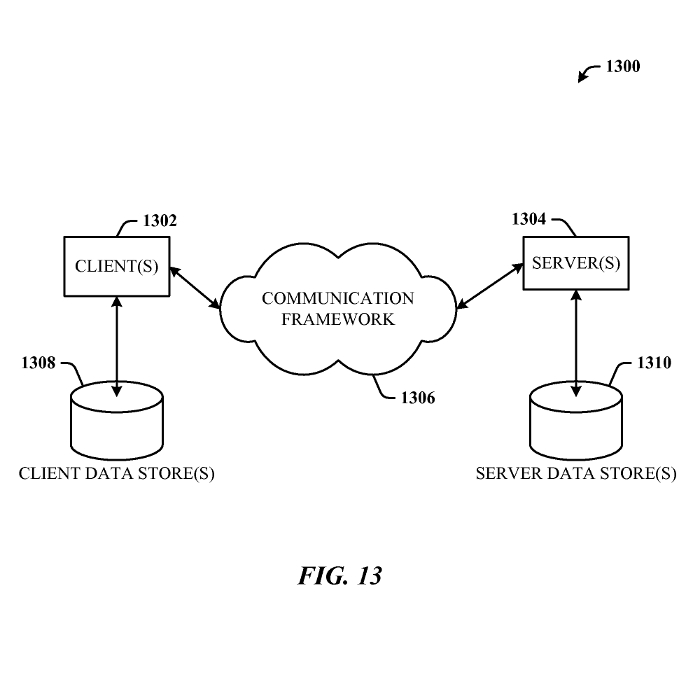

Referring now to FIG. 13, there is illustrated a schematic block diagram of an exemplary computing environment 1300 in accordance with another aspect. The system 1300 includes one or more client(s) 1302. The client(s) 1302 can be hardware and/or software (e.g., threads, processes, computing devices). The client(s) 1302 can house cookie(s) and/or associated contextual information by employing the subject innovation, for example.

The system 1300 also includes one or more server(s) 1304. The server(s) 1304 can also be hardware and/or software (e.g., threads, processes, computing devices). The servers 1304 can house threads to perform transformations by employing the invention, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates sale of online advertising space, comprising:
an aggregation component that aggregates advertisement space information associated with online advertisements; and
a transaction component that facilitates transacting subsets of the aggregated advertisement space information to bidders as a function of supply and demand.

2. The system of claim 1, wherein the aggregation component receives information about online advertising space that is now available.

3. The system of claim 1, wherein the aggregation component receives information about online advertising space will become available in the future.

4. The system of claim 1, wherein the aggregation component receives information about online advertising space that is predicted by prediction analysis to become available in the future.

5. The system of claim 1, wherein the subsets of the aggregated advertisement space information are valuated based on supply and demand.

6. The system of claim 1, wherein the transaction component facilitates purchase of options to buy online advertising space.

7. The system of claim 1, wherein the transaction component facilitates purchase of futures related to advertising space.

8. The system of claim 1, wherein the transaction component facilitates pricing of the subsets of the aggregated space information, and sale thereof based on received bids.

9. The system of claim 1, wherein the aggregation component groups the advertisement space information according to categories.

10. The system of claim 1, wherein the aggregation component groups the advertisement space information according to at least one of type and size.

11. The system of claim 1, further comprising a machine learning and reasoning component that employs a probabilistic and/or statistical-based analysis to prognose or infer an action that a user desires to be automatically performed.

12. The system of claim 1, further comprising a market component that interfaces to a national market exchange system for communication of market information.

13. The system of claim 1, wherein the aggregation component groups the ad space information according to class based on aspects desired by the bidders.

14. A computer-implemented method of transacting online advertising space, comprising acts of:
receiving advertising space information related to online advertising space of a web location;
accumulating the received advertising space information;
grouping the advertising space information into sets based in part on characteristics of the associated advertising space; and
receiving offers to buy the sets of the advertising space from bidders based on supply and demand data.

15. The method of claim 14, further comprising at least one of:
generating the sets of advertising space based on the supply and demand data for related advertising space; and
offering for bid advertisements and/or the advertisement space based on dynamically sensed contextual cues.

16. The method of claim 14, further comprising tracking historical information related to transactions associated with the offers to buy.

17. The method of claim 14, wherein the act of receiving is associated with an auction process in which a vendor bids for the advertisement space against all other bidders.

18. The method of claim 14, further comprising generating profile information which is used to valuate the advertising space.

19. The method of claim 14, further comprising utilizing the advertising space for informational purposes, other than for selling a product or service.

20. A computer-executable system for transacting online advertising space, comprising:
computer-implemented means for receiving advertising space information related to online advertising space of web locations;
computer-implemented means for accumulating the received advertising space information for processing;
computer-implemented means for clustering the advertising space information into related sets based in part on characteristics of the associated advertising space; and
computer-implemented means for transacting sales and offers to buy the sets of the advertising space from bidders as a function of supply and demand data.
